(19) United States
(12) Patent Application Publication
(10) Pub. No.: US 2026/0036948 A1
(43) Pub. Date: Feb. 5, 2026

(54) SECONDARY CONTROL SYSTEM

(71) Applicant: SAIF Autonomy Ltd, Waterbeach (GB)

(72) Inventors: Matthew HARRIS, Waterbeach (GB); Kyle THOMAS, Waterbeach (GB)

(73) Assignee: SAIF Autonomy Ltd, Waterbeach (GB)

(21) Appl. No.: 19/207,111

(22) Filed: May 13, 2025

(30) Foreign Application Priority Data
Aug. 2, 2024 (GB) 2411413.4

(51) Int. Cl. G05B 13/02; G05B 23/02

(52) U.S. Cl. CPC G05B 13/0265; G05B 23/0289

(57) ABSTRACT

A secondary control system configured to be provided between a primary control system and at least part of a main system, wherein the primary control system is configured to provide control instructions to the main system, the secondary control system comprising: a monitoring module to determine a current state and/or a future state of the main system; a control switching module configured to switch control of the main system from the primary control system to the secondary control system, wherein the control switching module is configured to: allow the control instructions from the primary control system to be provided to the main system, prevent the control instructions from being provided to the main system, or provide alternative control instructions to the main system.

### CROSS-REFERENCE TO RELATED PATENT APPLICATIONS

This application claims priority and benefit of United Kingdom Patent Application No.: 2411413.4, entitled “SECONDARY CONTROL SYSTEM” filed on Aug. 2, 2024, which is incorporated herein by reference in its entirety.

### TECHNICAL FIELD

The present disclosure relates to a secondary control system for controlling a main system controlled by a primary control system. In a specific example, the main system may be an autonomous physical system, such as an autonomous vehicle and the primary control system may be machine learning-based.

### BACKGROUND

Artificial intelligence (AI) or machine learning (ML) based controllers for cyber-physical systems offer many benefits. However, one of the main challenges facing the adoption of AI-based controllers in cyber-physical systems is “assurance”. Assurance is the challenge of ensuring that AI controlled systems behave reliably, safely, securely and predictably, especially in critical applications. The complexity, non-deterministic, or “black-box” nature of AI algorithms, potential biases in data, and the unpredictability of AI behaviour in diverse scenarios make assurance difficult. Given the tremendous action space and vast number of initial conditions, it is prohibitively expensive and even impossible to exhaustively test an AI controller to guarantee safety and security of the cyber-physical system. Therefore, alternative approaches are needed.

It is an aim of the present disclosure to at least partially address some of the problems above.

### SUMMARY

According to a first aspect of the disclosure there is provided a secondary control system configured to be provided between a primary control system and at least part of a main system, wherein the primary control system is configured to provide control instructions to the main system, the secondary control system comprising: a monitoring module configured to determine a current state and/or a future state of the main system; a control switching module configured to switch control of the main system from the primary control system to the secondary control system, wherein the control switching module is configured to: allow the control instructions from the primary control system to be provided to the main system if the determined current and/or future state satisfies a predefined set of conditions, and prevent the control instructions from being provided to the main system if the determined current and/or future state fails to satisfy the predefined set of conditions, and provide alternative control instructions to the main system, when the determined current and/or future state fails to satisfy the predefined set of conditions; wherein the secondary control system is reconfigurable, when in situ between the primary control system and the main system, to change at least one of: the predefined set of conditions and the predefined alternative control instructions provided to the main system.

According to a second aspect of the disclosure there is provided a secondary control system configured to be provided between a primary control system and at least part of a main system, wherein the primary control system is configured to provide control instructions to the main system, the secondary control system comprising: a monitoring module configured to determine a current state and/or a future state of the main system; a control switching module configured to switch control of the main system from the primary control system to the secondary control system, wherein the control switching module is configured to: allow the control instructions from the primary control system to be provided to the main system if the determined current and/or future state satisfies a predefined set of conditions, and prevent the control instructions from being provided to the main system if the determined current or future state fails to satisfy the predefined set of conditions, and provide alternative control instructions to the main system, when the determined current and/or future state fails to satisfy the predefined set of conditions; wherein the control instructions from the primary control system are generated by a machine learning or artificial intelligence algorithm and the alternative control instructions from the secondary control system are generated deterministically.

Optionally, the control instructions from the primary control system are generated non-deterministically. Optionally, the control instructions from the primary control system are generated by a machine learning or artificial intelligence algorithm.

Optionally, the alternative control instructions from the secondary control system are generated deterministically.

Optionally, the control switching module is configured to select one or more predefined secondary control processes for generating alternative control instructions to be provided to the main system from a plurality of possible predefined secondary control processes, based on the determined current state and/or future state of the main system. Optionally, the secondary control system is reconfigurable, when in situ between the primary control system and the main system, to change which predefined secondary control processes are selected based on which determined current state and/or future state of the main system.

Optionally, the main system in an autonomous physical system. Optionally, the main system is an autonomous vehicle. Optionally, the main system is an unmanned aerial vehicle or unmanned spacecraft.

Optionally, the predefined set of conditions define desired parameters for the operation of one or more sub-systems forming the main system.

Optionally, the predefined set of conditions define threshold limits for operating parameters of the one or more sub-systems, or threshold limits for parameters calculated from operating parameters of the one or more sub-systems, said operating parameters being received by the secondary control system from the main system.

Optionally, the one or more sub-systems comprise one or more of a sensor system or an effector system.

Optionally, the predefined set of conditions define desired parameters for the location of the main system in physical space. Optionally, the predefined set of conditions define a region of physical space.

Optionally, the predefined set of conditions define desired parameters for the motion of the main system. Optionally, the predefined set of conditions define threshold limits for the speed and/or trajectory of the main system.

Optionally, at least one of the monitoring module and the control switching module is reconfigurable based on one or more configurable parameters.

Optionally, the configurable parameters are initialised to the monitoring module or control switching module based on a configuration data file provided to the secondary control system.

According to a third aspect of the disclosure there is provided a computer system comprising the secondary control system of any preceding aspect and the primary control system.

According to a fourth aspect of the disclosure there is provided a system comprising the secondary control system of the first or second aspect and the main system. Optionally, the system further comprises the primary control system.

According to a fifth aspect of the disclosure there is provided A computer implemented method of controlling a main system, comprising: providing a secondary control system between a primary control system and at least part of a main system, wherein the primary control system is configured to provide control instructions to the main system, the secondary control system carrying out the following steps:
determining a current state and/or a future state of the main system;
switching control of the main system from the primary control system to the secondary control system, wherein the switching:
allows the control instructions from the primary control system to be provided to the main system if the determined current and/or future state satisfies a predefined set of conditions, and prevents the control instructions from being provided to the main system if the determined current or future state fails to satisfy the predefined set of conditions, and
provides alternative control instructions to the main system, when the determined current and/or future state fails to satisfy the predefined set of conditions; and
reconfiguring the secondary control system, when in situ between the primary control system and the main system, to change at least one of: the predefined set of conditions and the predefined alternative control instructions provided to the main system.

According to a sixth aspect of the disclosure there is provided a computer program comprising instructions which, when the program is executed by a computer, cause the computer to carry out the method of the fifth aspect.

According to a seventh aspect of the disclosure there is provided a data processing system comprising means for carrying out the method of the fifth aspect.

According to an eighth aspect of the disclosure there is provided a computer-readable storage medium comprising instructions which, when executed by a computer, cause the computer to carry out the method of the fifth aspect.

### BRIEF DESCRIPTION OF THE DRAWINGS

Further features of the disclosure will be described below, by way of non-limiting examples and with reference to the accompanying drawings, in which:

FIG. 1 schematically shows a cyber-physical system;

FIG. 2 schematically shows a cyber-physical system including a secondary control system according to the disclosure;

FIG. 3 schematically shows a secondary control system according to the disclosure;

FIG. 4 schematically shows a monitoring module and configuration data file; and

FIG. 5 illustrates an exemplary implementation of the secondary control system.

### DETAILED DESCRIPTION

The present disclosure relates to a secondary control system configured to be provided between a primary control system and at least part of a main system. The secondary control system is configured to intercept control instructions from the primary control system to the main system, and/or provide alternative control instructions to the main system.

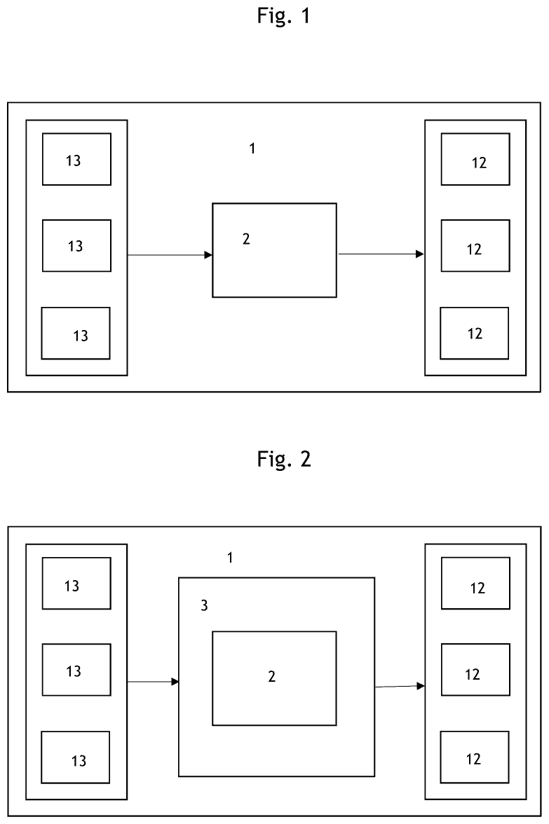

FIG. 1 schematically shows an example main system 1 and primary control system 2. As shown in FIG. 1, the main system 1 may comprise hardware components in the form of one or more effectors 12 configured to be controlled by the primary control system 2. An effector may be defined as a device or component responsible for converting digital control signals into physical actions. Examples of effectors 12 may include motors, actuators, robotic arms, valves, relays, switches, light sources, etc.

The primary control system 2 may provide control signals to the effectors, either directly or indirectly via one more sub-controllers between the primary control system 2 and an effector. In some examples, a sub-controller may be configured to receive instructions from the primary control system 2, and control one or more effectors based on the instructions from the primary control system 2.

In a specific example, the main system 1 may be an autonomous vehicle, such as an unmanned aerial system (UAS), or an unmanned spacecraft. Effectors may include a plurality of motors or actuators for manoeuvring the vehicle, for example. In an example, the primary control system 2 may provide instructions for execution of a specific manoeuvre and a sub-controller may coordinate the control of individual motors or actuators in order to execute the instructed manoeuvre. For a UAS, a sub-controller such as this is often referred to as a flight controller.

The primary control system 2 may form a physical part of the main system 1. Alternatively, the primary control system 2 may be physically separate from of the main system 1. In some examples, the primary control system 2 may comprise parts that form a physical part of the main system 1 and parts which are physically separate from of the main system 1.

In some examples, where at least a part of the primary control system 2 is physically separate from the main system 1, at least some instructions from the primary control system 2 may be wirelessly transmitted from the primary control system 2 to the main system 1. Accordingly, the main system 1 may comprise a wireless communication module for communication with the primary control system 2. The primary control system 2 may be a ground station for controlling an autonomous vehicle, such as a UAS, for example.

In other examples, what are considered sub-controllers in the above example may be considered primary control systems. For example, a flight controller may be considered a primary control system. Further, multiple primary control systems may be associated with the main system, each having a corresponding secondary control system according to the disclosure associated therewith.

In a specific example, the primary control system 2 is configured to generate control instructions non-deterministically. For example, instructions may be generated by a non-deterministic algorithm, e.g. in a probabilistic manner. A non-deterministic algorithm may refer to an algorithm for which, even for the same input, the algorithm can exhibit different behaviours on different runs. In some examples, instructions may be generated by a machine learning or artificial intelligence algorithm. In a specific example, the machine learning algorithm may be a reinforcement learning algorithm.

In cases where instructions are generated non-deterministically, it may be difficult to ensure that instructions provided by the primary controller will ensure the main system 1 remains within predefined bounds of operation.

As shown in FIG. 1, the main system 1 may comprise further hardware components in the form of sensors 13. The sensors 13 may be configured to provide information to the primary control system 2. The primary control system 2 may generate control instructions based on information from the sensors 13. For example, the primary control system 2 may receive input from one or more sensors 13, analyse the input and generate control instructions for controlling the main system 1, based on the analysis. In some examples, the primary control system 2 may generate control instructions in order to meet a predefined objective. In the case of a UAS, the predefined objective may be to fly the UAS to a predefined location or following a predefined route.

The sensors 13 may include sensors configured to provide information relating to the performance or behaviour of components forming the main system 1, e.g. one or more effectors such as actuators, motors, etc. Such sensors may include: ammeters, voltmeters, proximity sensors. The sensors may, alternatively or additionally, include sensors configured to provide information relating to the performance or behaviour of the main system 1 as a whole, e.g. orientation, location, altitude, velocity, angular velocity, internal temperature, proximity to a foreign object, motor vibration, safety interlocks, payload activation, power consumption, fuel consumption. Such sensors may include: cameras (e.g. EO, IR, Multispectral), Radar, LiDAR, acoustic sensors, accelerometers, gyro sensors, GPS, Radar, magnetometer, compass, IMU, proximity sensors, ammeters, voltmeters, temperature sensors, transponders (ADS-B, IFF), LiDAR. The sensors may, alternatively or additionally, include sensors configured to provide information relating to the environment in which the main system 1 operates, e.g. visibility, weather, external temperature, proximity to obstacles or hazards. Such sensors may include: cameras (EO, IR, multispectral), LiDAR, Radar, ultrasonic.

In some examples, output from one or more sensors 13 may be combined to provide information that is input to the primary control system 2, e.g. in a sensor fusion process. Sensor fusion may refer to the process of combining sensor data from different sources such that the resulting information has less uncertainty than would be possible when these sources were used individually. In a specific example, sensor fusion may be used to more accurately determine location based on one or more of: GPS data, accelerometer data, gyro sensor data, magnetometer data, compass data, IMU data visual odometer data.

FIG. 2 shows the system of FIG. 1 further comprising a secondary control system 3 according to the disclosure. As shown, the secondary control system 3 is provided between a primary control system 2 and at least a part of the main system 1. As shown, the secondary control system 3 may be provided between the primary control system 2 and one or more effectors controlled by the primary control system 2. Accordingly, the secondary control system 3 may intercept control instructions from the primary control system 2 before they reach the one or more effectors. As shown, at least part of the secondary control system 3 may additionally be provided between the one or more sensors 13 and the primary control system 2.

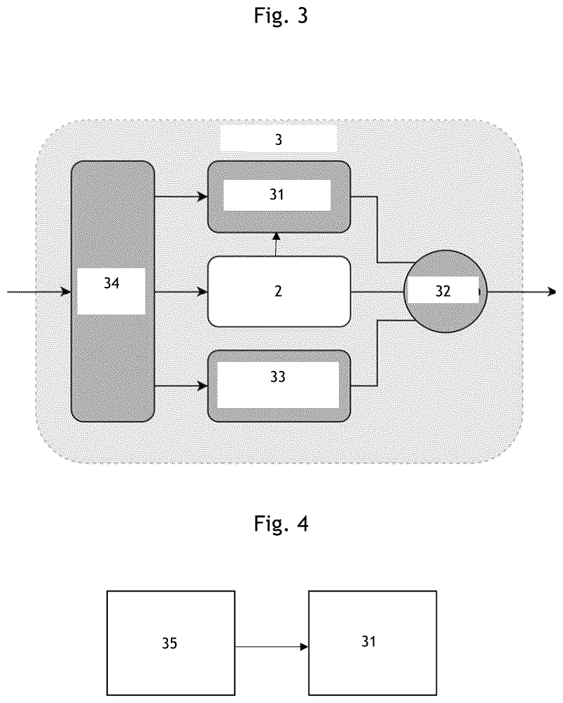

FIG. 3 schematically shows an example secondary control system 3 in further detail. As shown, the secondary control system 3 comprises a monitoring module 31 configured to determine a current state and/or a future state of the main system 1. As shown, the secondary control system 3 further comprises a control switching module 32 configured to switch control of the main system 1 from the primary control system 2 to the secondary control system 3 based on a determination by the monitoring module 31.

As shown, the secondary control system 3 may further comprise an input module 34. The input module 34 may be configured to determine the accuracy of data received form the one or more sensors 13.

The control switching module 32 may allow the control instructions from the primary control system 2 to be provided to the main system 1 if the determined current or future state of the main system 1 satisfies a predefined set of conditions. The control switching module 32 may prevent the control instructions from the primary control system 2 being provided to the main system 1 if the determined current and/or future state of the main system 1 fails to satisfy the predefined set of conditions. The control switching module 32 may additionally provide alternative control instructions to the main system 1, when the determined current and/or future state of the main system 1 fails to satisfy the predefined set of conditions.

Generally, the control of the main system 1 is switched between the primary control system 2 and the secondary control system 3 based on the determined current and/or future state of the main system 1 and the predefined set of conditions.

In an example, the alternative control instructions may be generated by one or more secondary control processes. One of the one or more secondary control processes may be selected to provide alternative control instructions to the main system 1 based on how the determined current and/or future state of the main system 1 fails to satisfy the predefined set of conditions, e.g. which of the predefined set of conditions are not satisfied and/or to what extent.

In an example, the control switching module 32 may be configured to switch between at least two operating states. In a first operating state, the control switching module 32 allows the control instructions from the primary control system 2 to be provided to the main system 1. In a subsequent state, the control switching module 32 may prevent the control instructions from the primary control system 2 being provided to the main system 1 and, optionally, provide alternative control instructions to the main system 1. The control switching module 32 may be configured to switch to one of a plurality of subsequent states. Different subsequent states may relate to different secondary control processes for providing different alternative control instructions.

Generally, the control switching module 32 is switched between the primary control system 2 and one or more secondary control processes of the secondary control system 3, based on the determined current and/or future state of the main system 1 and the predefined set of conditions.

The different secondary control processes may be based on different predefined algorithms. In some examples, the secondary control processes may be configured to provide instructions that cause the main system 1 to take avoidant or corrective action, when the determined current and/or future state of the main system 1 fails to satisfy the one or more conditions, in order that the main system 1 remains in, or returns to, a state which satisfies the one or more conditions. Accordingly, the secondary control processes may provide avoidant or corrective control of the main system 1.

When the main system 1 returns to a state which satisfies the one or more conditions, or for which a relevant future state satisfies the one or more conditions, the control switching module 32 may be configured to switch control back to the primary control system 2. Generally, the monitoring module 31 may continuously, or periodically, monitor whether or not the current and/or future state of the main system 1 satisfies the one or more conditions and cause the control switching module 32 to switch between control by the primary control system 2 and control by the secondary control system 3, as required.

In a specific example, e.g. an example in which the primary control system 2 is configured to generate control instructions non-deterministically, the alternative control instructions may be generated deterministically, e.g. by a deterministic algorithm. Generally, the control switching module 32 may provide alternative control instructions generated by different deterministic algorithms.

As shown in FIG. 3, the alternative control instructions may be provided by a secondary control module 33 of the secondary control system 3. As shown in FIG. 3, the control switching module 32 may receive the control instructions from the primary control system 2 and from the secondary control module 33 of the secondary control system 3. In the first state, the control switching module 32 may allow control instructions from the primary control system 2 to pass through the secondary control system 3 and on to the main system 1. In a subsequent state, the control switching module 32 may block instructions from the primary control unit, but provide control instructions from the secondary control module 33 to the main system 1.

The control switching module 32 may switch control based on instructions received from the monitoring module 31. For example, when all of the predefined conditions are satisfied, the monitoring module 31 may provide instructions to the control switching module 32 to switch to or maintain control by the primary control system 2. When one or more of the predefined conditions are not satisfied, the monitoring module 31 may provide instructions to the control switching module 32 to switch control to the secondary control system 3.

In some examples, the monitoring module 31 may additionally provide instructions to the control switching module 32 to switch control to one of a plurality of secondary control processes. In some examples, the monitoring module 31 may provide instructions to the control switching module 32 to switch control to the secondary control module 33 and provide instructions to the secondary control module 33 to provide control instructions to the control switching module 32 based on one of a plurality of secondary control processes.

In some examples, the predefined set of conditions may define a permitted operation envelope defining acceptable bounds of operation of the main system 1. Different conditions may relate to different parameters relating to the operation of the main system 1 or interaction between the main system 1 and the environment in which it operates.

In some examples, at least some of the predefined conditions may define desired parameters for the operation of one or more sub-systems or physical components forming the main system 1. For example, various sub-systems of the main system 1 may be associated with predefined safe operational ranges. Examples may include, actuator positions, motor speeds, motor temperature, payload states or modes (such as on/off or released/not released). In some examples, such predefined conditions may relate to the accuracy of sensor data determined by the input module 34.

In some examples, at least some of the predefined conditions may relate to the performance or behaviour of the main system 1 as a whole, e.g. orientation, location, altitude, velocity, angular velocity, internal temperature, proximity to a foreign object, specific platform states or modes (such as take-off, landing or refuelling states), fault detection (such as motor/actuator failures or low fuel/power).

The monitoring module 31 may be configured to model the performance or behaviour of the main system 1 and/or the environment in which it operates. For example, the monitoring module 31 may implement a digital twin of the main system 1. A digital twin may refer to virtual representation of the main system 1 designed to reflect the performance or behaviour real main system 1.

The monitoring module 31 may comprise one or more algorithms to model the performance or behaviour of the main system 1 and/or the environment in which it operates. The monitoring module 31 may receive input from one or more sensors 13 of the main system 1 for modelling the main system 1. The monitoring module 31 may additionally receive the control instructions from the primary control system 2 as input for modelling the main system 1.

The modelling may comprise determining a current state of the main system 1 and/or a future state of the main system 1. A state may refer to a combination of one or more of the parameters relating to the operation of the main system 1 or interaction between the main system 1 and the environment in which it operates. A future state may be determined based on the current performance or behaviour of the main system 1, e.g. based on the control instructions provided by the primary control system 2, extrapolated into a point in the future based on the modelling.

In some examples, multiple possible future states may be determined, e.g. based on different possible future control instructions. For example, in relation to the location of the main system 1, multiple possible future locations of the main system 1 may be determined. In some examples, different possible states may be assigned a weighting, e.g. based on a probability of occurring. Some possible future states may satisfy the predefined conditions and some possible future states may not satisfy the predefined conditions. In an example, if a weighting assigned to a state which does not satisfy predefined conditions satisfies a predefined threshold, then the control of the system may be switched to the secondary control system 3, e.g. to take avoidant action.

The secondary control system 3 may be provided by hardware forming a physical part of the main system 1. In some examples, the secondary control system 3 may be provided as a computer programme executed by hardware, e.g. a processor. In some examples, a processor implementing the secondary control system 3 may be specifically provided for that purpose, i.e. the processor may only execute functions associated with the secondary control system 3. In other examples, the secondary processing system may be implemented by a processor that additionally executes functions that are not associated with the secondary control system 3. In some examples, functions that are not associated with the secondary control system 3 may include functions associated with the primary control system 2, a sub-controller of the main system 1.

In a preferred example, the secondary control system 3 may be reconfigurable, when in situ between the primary control system 2 and the main system 1. The secondary control system 3 may be reconfigurable to change at least one of: the predefined set of conditions and the predefined alternative control instructions. In a specific example, the secondary control system 3 may be reconfigurable to change which secondary control process provides the alternative control instructions and/or under what circumstances.

The control system may be reconfigurable based on one or more configurable parameters. At least some of the configurable parameters may define at least a subset of the predefined set of conditions defining the acceptable operational envelope of the main system 1, e.g. any of the predefined conditions described above. At least some configurable parameters may determine thresholds relating to at least a subset of the configurable parameters defined above, at which control is switched from the primary control system 2 to the secondary control system 3. These thresholds may be set within the acceptable operational envelope to provide a buffer zone, e.g. to ensure the system has sufficient time and space to take avoidant action. The thresholds may be absolute values or may be set by reference to the configurable parameters above, e.g. as a percentage thereof or distance therefrom.

At least some of the configurable parameters may define which conditions of the predefined set of conditions are monitored by the monitoring module 31, and/or at what frequency.

At least some of the configurable parameters may determine which secondary control process is selected for a given determination by the monitoring module 31. For example, different secondary control processed may be suitable depending whether the main system 1 fails to satisfy a predefined condition by exceeding an upper limit or falling below a lower limit.

In a specific example, the monitoring module 31 of the secondary control system 3 may be reconfigurable. In this example, the control switching module 32 and secondary control module 33 may be non-configurable. The monitoring module 31 may comprise configurable parts and non-configurable parts.

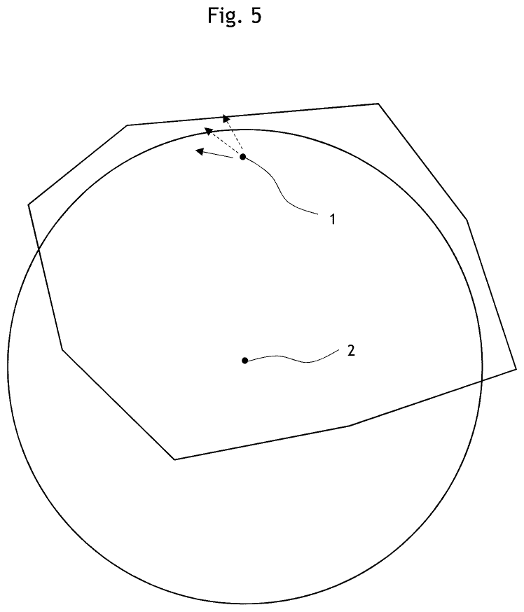

As shown in FIG. 4, the configurable parameters may be provided in a configuration data file 35 accessible by the secondary control system 3, e.g. the monitoring module 31 specifically. The configurable parameters may be provided to the configurable parts of the secondary control system 3 based on the configuration data file 35. This may be performed during an initialisation process of a computer program executing the secondary control system 3 or a part thereof, e.g. the monitoring module 31. A configuration data file 35 may be replaced by a new configuration data file 35 while the secondary control system 3 is in situ within the main system 1. Accordingly, the secondary control system 3 can be reconfigured without the need to provide a new secondary control system 3 in its entirety.

In a specific example, the main system 1 may be a multirotor UAS controlled by a ground station. The primary control system 2 may comprise be a machine learning-based controller forming part of the ground station. The primary control system 2 is configured to provide control instructions to the multiple rotors to manoeuvre the UAS, via a flight controller as a sub-controller. The main system 1 comprises a communication module connected to the flight controller and configured to receive control instructions from the ground station. The secondary control system 3 is connected to the main system 1 between the communication module and the flight controller.

The monitoring module 31 of the main controller may be configured determine the state of the main system 1 with respect to any one of: altitude, velocity (airspeed), internal temperature and angular velocity, absolute location, and relative location from the ground station.

Predefined conditions may be set with respect to the above based on a configuration data file. Upper and/or lower limits may be set with respect to altitude, velocity (airspeed), angular velocity and internal temperature to define a performance envelope (permitted range) of the main system 1 and a threshold is set based on a buffer factor as a percentage of the performance envelope to define the conditions at which control should be switched between the primary control system 2 and the secondary control system 3.

Secondary control processes are set with respect to the predefined conditions, including respective secondary control processes to lower the altitude, lower velocity, stabilise the main system 1 and cool the main system 1 when the thresholds are exceeded (and vice versa with respect to lower limits). Control may be switched to one of the above secondary control processed when the current state of the system is determined breach a respective predefined condition defined by a respective threshold. The buffer factor set with respect to he performance envelope reduces the likelihood of a breach of the performance envelope.

Further, predefined conditions may be set with respect to absolute location, and relative location from the ground station, e.g. as shown respectively by the polygon and circular boundaries shown in FIG. 5. These may be set based on mapping data, which defines the permitted range of the main system 1 in airspace. Thresholds for switching control from the primary control system 2 to the secondary control system 3 may be set with respect to a future state of the system breaching the permitted range. The future state may be dynamically set with respect to the trajectory and velocity of the main system 1 for example, e.g. ensuring enough time and/or distance to take avoidant action.

Secondary control processes may include one or more processes to change the trajectory of the main system 1 to avoid the future state of the system breaching the permitted range. The trajectory may be determined by the monitoring module 31. For example, the monitoring module 31 may calculate the future state of the main system 1 for multiple trajectories and/or velocities, including a current trajectory and/or velocity, as shown by the arrows in FIG. 5. If the future state for the current trajectory and/or velocity is considered to breach the predetermined range (e.g. the centre arrow, dashed line denoting breach) and a future state for an alternative trajectory and/or velocity is considered not to breach the predetermined range (e.g. the left arrow, solid line denoting no breach). The secondary control process may alter the trajectory of the main system 1 to the alternative trajectory (left arrow).

The predefined conditions may be set with respect to a specific mission the main system 1 is controlled to perform. Different missions may require different predefined conditions. For example, the permitted altitude or velocity may be different and or the permitted location of the main system 1. Accordingly, it is important that the secondary control system 3 can be easily reconfigured. In the present example, a new configuration data file 35 including new configurable parameters defining new predefined conditions is provided to the secondary control system 3 and used to reconfigure the secondary control system 3.

In a specific example, the secondary control system may collect data regarding when control is switched from the primary control system to the secondary control system. This data may then be used to train the primary control system 2, e.g. a machine learning-based primary control system.

It should be understood that the above described examples are for illustrative purposes only and the invention may otherwise be implemented without departing from the spirit or scope of the invention as defined by the appended claims.

What is claimed is:

1. A secondary control system configured to be provided between a primary control system and at least part of a main system, wherein the primary control system is configured to provide control instructions to the main system, the secondary control system comprising:
a monitoring module configured to determine a current state and/or a future state of the main system;
a control switching module configured to switch control of the main system from the primary control system to the secondary control system, wherein the control switching module is configured to:
allow the control instructions from the primary control system to be provided to the main system if the determined current and/or future state satisfies a predefined set of conditions, and prevent the control instructions from being provided to the main system if the determined current and/or future state fails to satisfy the predefined set of conditions, and
provide alternative control instructions to the main system, when the determined current and/or future state fails to satisfy the predefined set of conditions;
wherein the secondary control system is reconfigurable, when in situ between the primary control system and the main system, to change at least one of: the predefined set of conditions and the predefined alternative control instructions provided to the main system.

2. The secondary control system of claim 1, wherein the control instructions from the primary control system are generated non-deterministically.

3. The secondary control system of claim 1, wherein the control instructions from the primary control system are generated by a machine learning or artificial intelligence algorithm.

4. The secondary control system of claim 1, wherein the alternative control instructions from the secondary control system are generated deterministically.

5. The control system of claim 1, wherein the control switching module is configured to select one or more predefined secondary control processes for generating alternative control instructions to be provided to the main system from a plurality of possible predefined secondary control processes, based on the determined current state and/or future state of the main system.

6. The secondary control system of claim 5, wherein the secondary control system is reconfigurable, when in situ between the primary control system and the main system, to change which predefined secondary control processes are selected based on which determined current state and/or future state of the main system.

7. The secondary control system of claim 1, wherein the main system in an autonomous physical system, optionally an autonomous vehicle, preferably an unmanned aerial vehicle or an unmanned spacecraft.

8. The secondary control system of claim 1, wherein the predefined set of conditions define desired parameters for the operation of one or more sub-systems forming the main system.

9. The secondary control system of claim 8, wherein the predefined set of conditions define threshold limits for operating parameters of the one or more sub-systems, or threshold limits for parameters calculated from operating parameters of the one or more sub-systems, said operating parameters being received by the secondary control system from the main system.

10. The secondary control system of claim 8, wherein the one or more sub-systems comprise one or more of a sensor system or an effector system.

11. The secondary control system of claim 1, wherein the predefined set of conditions define one or more of: desired parameters for a location of the main system in physical space; a region of physical space; desired parameters for a motion of the main system; and threshold limits for a speed and/or trajectory of the main system.

12. The secondary control system of claim 1, wherein at least one of the monitoring module and the control switching module is reconfigurable based on one or more configurable parameters.

13. The secondary control system of claim 12, wherein the configurable parameters are initialized to the monitoring module or control switching module based on a configuration data file provided to the secondary control system.

14. A computer system comprising the secondary control system of claim 1 and the primary control system.

15. A system comprising the secondary control system of claim 1 and the main system.

16. The system of claim 15, further comprising the primary control system.

17. A computer implemented method of controlling a main system, comprising:
providing a secondary control system between a primary control system and at least part of a main system, wherein the primary control system is configured to provide control instructions to the main system, the secondary control system carrying out the following steps:
determining a current state and/or a future state of the main system;
switching control of the main system from the primary control system to the secondary control system, wherein the switching:
allows the control instructions from the primary control system to be provided to the main system if the determined current and/or future state satisfies a predefined set of conditions, and prevents the control instructions from being provided to the main system if the determined current and/or future state fails to satisfy the predefined set of conditions, and
provides alternative control instructions to the main system, when the determined current and/or future state fails to satisfy the predefined set of conditions; and
reconfiguring the secondary control system, when in situ between the primary control system and the main system, to change at least one of: the predefined set of conditions and the predefined alternative control instructions provided to the main system.

18. A computer program comprising instructions which, when the program is executed by a computer, cause the computer to carry out the method of claim 17.

19. A data processing system comprising means for carrying out the method of claim 17.

20. A computer-readable storage medium comprising instructions which, when executed by a computer, cause the computer to carry out the method of claim 17.
